(19) United States
(12) Patent Application Publication
(10) Pub. No.: US 2017/0028416 A1
(43) Pub. Date: Feb. 2, 2017

(54) Fluid Distribution Assembly

(71) Applicant: Mark Duitsman, Victorville, CA (US)

(72) Inventor: Mark Duitsman, Victorville, CA (US)

(21) Appl. No.: 14/810,655

(22) Filed: Jul. 28, 2015

(51) Int. Cl. B05B 9/08; B05B 15/06

(52) U.S. Cl. CPC B05B 9/0822; B05B 15/065

(57) ABSTRACT

A fluid distribution assembly includes a reservoir that may contain a fluid. A pump is coupled to the reservoir such that the pump may be manipulated thereby facilitating the pump to selectively pressurize air within the reservoir. A hose is fluidly coupled to the reservoir such that the hose may selectively release the fluid within the reservoir when the pump pressurizes the air within the reservoir. A nozzle is fluidly coupled to the hose such that the nozzle may be manipulated. Thus, the nozzle to selectively allows and restricts the flow of the fluid from the hose. A cap is removably coupled to the reservoir such that the cap may allow the reservoir to be filled with the fluid. A handle is coupled to the reservoir.

### BACKGROUND OF THE DISCLOSURE

### Field of the Disclosure

The disclosure relates to distribution devices and more particularly pertains to a new distribution device for containing and selectively distributing a fluid.

### SUMMARY OF THE DISCLOSURE

An embodiment of the disclosure meets the needs presented above by generally comprising a reservoir that may contain a fluid. A pump is coupled to the reservoir such that the pump may be manipulated thereby facilitating the pump to selectively pressurize air within the reservoir. A hose is fluidly coupled to the reservoir such that the hose may selectively release the fluid within the reservoir when the pump pressurizes the air within the reservoir. A nozzle is fluidly coupled to the hose such that the nozzle may be manipulated. Thus, the nozzle to selectively allows and restricts the flow of the fluid from the hose. A cap is removably coupled to the reservoir such that the cap may allow the reservoir to be filled with the fluid. A handle is coupled to the reservoir.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a fluid distribution assembly according to an embodiment of the disclosure.

FIG. 2 is a back view of an embodiment of the disclosure.

FIG. 3 is a right side view of an embodiment of the disclosure.

FIG. 4 is a perspective in-use view of an embodiment of the disclosure.

FIG. 5 is a perspective view of an alternative embodiment of the disclosure.

### DESCRIPTION OF THE PREFERRED EMBODIMENT

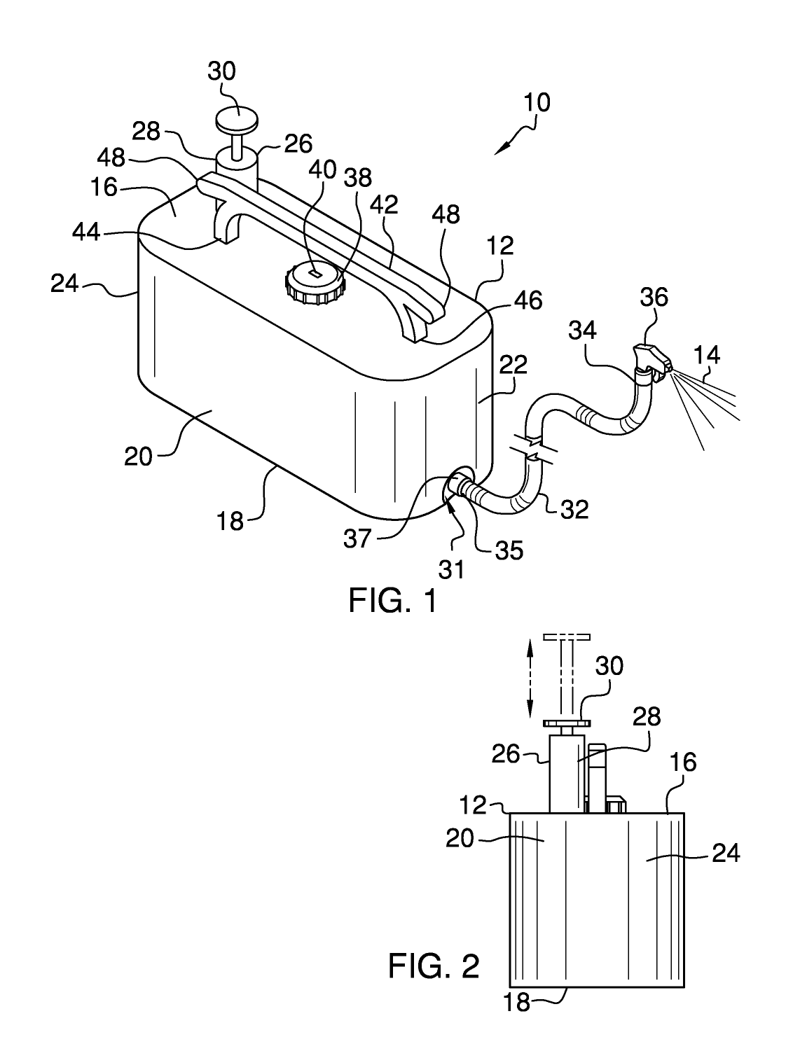

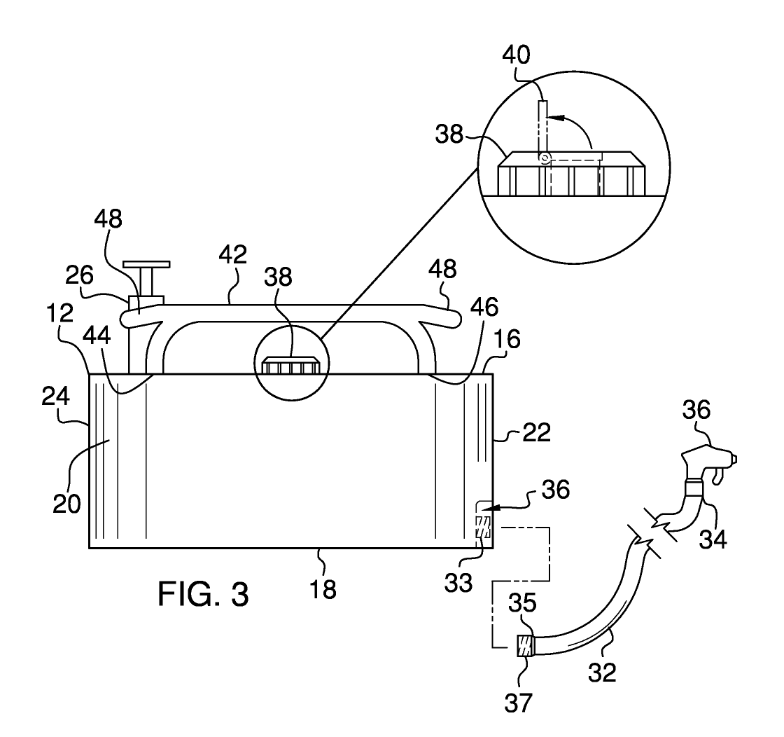

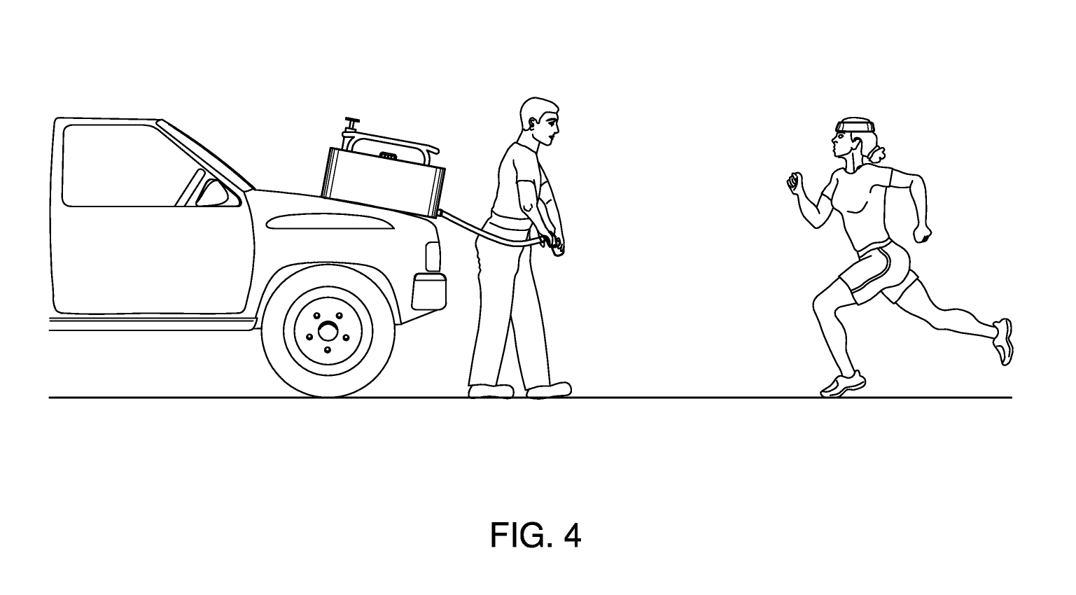

With reference now to the drawings, and in particular to FIGS. 1 through 5 thereof, a new distribution device embodying the principles and concepts of an embodiment of the disclosure and generally designated by the reference numeral 10 will be described.

As best illustrated in FIGS. 1 through 5, the fluid distribution assembly 10 generally comprises a reservoir 12 that may contain a fluid 14. The reservoir 12 has a top wall 16, a bottom wall 18 and a peripheral wall 20 extending between the top wall 16 and the bottom wall 18. The peripheral wall 20 has a first lateral side 22 and a second lateral side 24. The reservoir 12 may be comprised of a non toxic material such as BPA-free plastic or the like and the fluid 14 may comprise water or other beverage.

A pump 26 is coupled to the reservoir 12 such that the pump 26 may be manipulated thereby facilitating the pump 26 to selectively pressurize air within the reservoir 12. The pump 26 is coupled to and extends upwardly from the top wall 16. The pump 26 is in fluid communication with an interior of the reservoir 12. The pump 26 may comprise a hand pump or the like involving a cylindrical body 28 and a plunger 30 slidably coupled to the cylindrical body 28. The pump may be positioned adjacent to the second lateral side 24.

The first lateral side 22 has a well 31 extending inwardly therein and the well 31 is positioned adjacent to the bottom wall 18. A port 33 is coupled to and extends outwardly from said first lateral side 22 and the port 33 is in fluid communication with the interior of the reservoir 12. The port 33 is positioned within the well 31.

A hose 32 is fluidly coupled to the reservoir 12 such that the hose 32 may selectively release the fluid 14 within the reservoir 12 when the pump 26 pressurizes the air within the reservoir 12. The hose 32 has a first end 35 and a coupler 37 is coupled to the first end 35. The coupler 37 threadably engages the port 33 on the reservoir 12 such that the hose 32 extends away from the first lateral side 22. The hose 32 has a distal end 34 with respect to the first lateral side 22 when the hose is coupled to the port 33. A nozzle 36 is fluidly coupled to the distal end 34 of hose 32. The nozzle 36 may be manipulated thereby facilitating the nozzle 36 to selectively allow and restrict the flow of the fluid 14 from the hose 32.

A cap 38 is removably coupled to the reservoir 12 such that the cap 38 may allow the reservoir 12 to be filled with the fluid 14 and the cap 38 is positioned on the top wall 16. The cap 38 has a vent 40 therein such that the vent 40 may be manipulated. The vent 40 is positionable in a closed position such that the cap 38 retains the pressurized air within the reservoir 12. The vent 40 is positionable in an open position such that the cap 38 releases the pressurized air within the reservoir 12.

A handle 42 is coupled to the reservoir 12 and the handle 42 is positioned on the top wall 16. The handle 42 has a first end 44 and a second end 46. The handle 42 is curved between the first end 44 and the second end 46 such that the handle 42 has a U-shape. Each of the first end 44 and the second end 46 is coupled to the top wall 16. The handle 42 has a pair of lobes 48. Each of the lobes 48 extends outwardly from the handle 42 such that each of the lobes 48 is spaced from the top wall 16. Each of the lobes 48 is positioned proximate an associated one of the first end 44 and the second end 46. The hose 32 is wrapped around the handle 42 when the hose 32 is not in use. The hose 32 is positioned between the top wall 16 and each of the lobes 48.

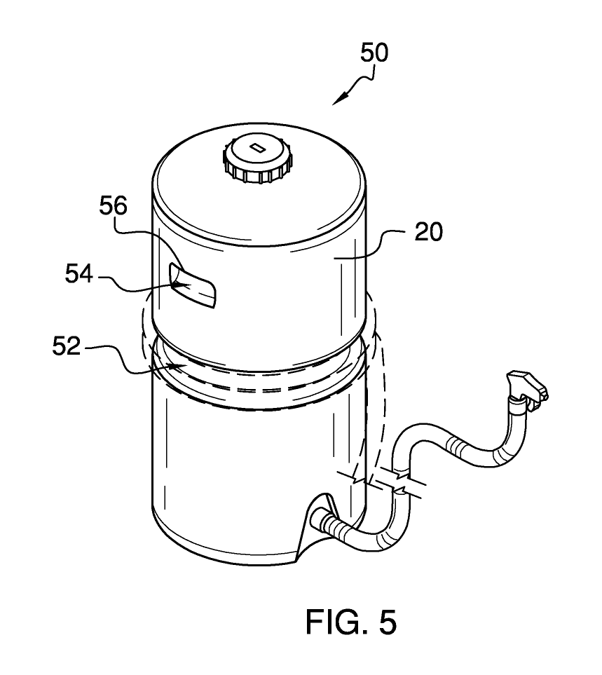

In an alternative embodiment 50 as shown in FIG. 5, the peripheral wall 20 may be curved such that the reservoir 12 has a cylindrical shape. The peripheral wall 20 may have a groove 52 extending inwardly therein and the groove 52 may be continuous. The hose 32 may be wrapped around the reservoir 12 such that the hose 32 is positioned within the groove 52. The hose 32 is wrapped around the reservoir 12 when the hose 32 is not in use. The peripheral wall 20 has a well 54 extending inwardly therein to define a grip 56. The grip 56 is positioned between the top wall 16 and the groove 52.

In use, the cap 38 is removed and the fluid 14 is poured into the reservoir 12. The cap 38 is replaced and the pump 26 is manipulated to pressurize the air within the reservoir 12. The nozzle 36 is manipulated to release the fluid 14 from the nozzle 36 such that the fluid 14 may be consumed. The fluid 14 is consumed at sporting events such as marathons or the like involving extended periods of physical exertion.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid distribution assembly comprising:
a reservoir configured to contain a fluid;
a pump being coupled to said reservoir wherein said pump is configured to be manipulated thereby facilitating said pump to selectively pressurize air within said reservoir;
a hose being fluidly coupled to said reservoir wherein said hose is configured to selectively release the fluid within said reservoir when said pump pressurizes the air within said reservoir;
a nozzle being fluidly coupled to said hose wherein said nozzle is configured to be manipulated thereby facilitating said nozzle to selectively allow and restrict the flow of the fluid from said hose;
a cap being removably coupled to said reservoir wherein said cap is configured to allow said reservoir to be filled with the fluid; and
a handle being coupled to said reservoir.

2. The assembly according to claim 1, wherein:
said reservoir has a top wall, a bottom wall and a peripheral wall extending between said top wall and said bottom wall, said peripheral wall having a first lateral side and a second lateral side; and
said pump being coupled to and extending upwardly from said top wall, said pump being in fluid communication with an interior of said reservoir.

3. The assembly according to claim 2, further comprising said hose being coupled to and extending away from said first lateral side, said hose being positioned adjacent to an intersection of said first lateral side and said bottom wall, said hose having a distal end with respect to said first lateral side.

4. The assembly according to claim 1, wherein said cap is positioned on said top wall, said cap having a vent therein wherein said vent is configured to be manipulated, said vent being positionable in a closed position wherein said cap is configured to retain the pressurized air within said reservoir, said vent being positionable in an open position wherein said cap is configured to release the pressurized air within said reservoir.

5. The assembly according to claim 1, wherein:
said reservoir has a top wall; and
said handle is positioned on said top wall, said handle having a first end and a second end, said handle being curved between said first end and said second end such that said handle has a U-shape, each of said first end and said second end being coupled to said top wall.

6. The assembly according to claim 5, wherein said handle has a pair of lobes, each of said lobes extending outwardly from said handle such that each of said lobes is spaced from said top wall, each of said lobes being positioned proximate an associated one of said first end and said second end, said hose being wrapped around said handle such that said hose is positioned between said top wall and each of said lobes.

7. A fluid distribution assembly comprising:
a reservoir configured to contain a fluid, said reservoir having a top wall, a bottom wall and a peripheral wall extending between said top wall and said bottom wall, said peripheral wall having a first lateral side and a second lateral side;
a pump being coupled to said reservoir wherein said pump is configured to be manipulated thereby facilitating said pump to selectively pressurize air within said reservoir, said pump being coupled to and extending upwardly from said top wall, said pump being in fluid communication with an interior of said reservoir;
a hose being fluidly coupled to said reservoir wherein said hose is configured to selectively release the fluid within said reservoir when said pump pressurizes the air within said reservoir, said hose being coupled to and extending away from said first lateral side, said hose being positioned adjacent to an intersection of said first lateral side and said bottom wall, said hose having a distal end with respect to said first lateral side;
a nozzle being fluidly coupled to said hose wherein said nozzle is configured to be manipulated thereby facilitating said nozzle to selectively allow and restrict the flow of the fluid from said hose;
a cap being removably coupled to said reservoir wherein said cap is configured to allow said reservoir to be filled with the fluid, said cap being positioned on said top wall, said cap having a vent therein wherein said vent is configured to be manipulated, said vent being positionable in a closed position wherein said cap is configured to retain the pressurized air within said reservoir, said vent being positionable in an open position wherein said cap is configured to release the pressurized air within said reservoir; and
a handle being coupled to said reservoir, said handle being positioned on said top wall, said handle having a first end and a second end, said handle being curved between said first end and said second end such that said handle has a U-shape, each of said first end and said second end being coupled to said top wall, said handle having a pair of lobes, each of said lobes extending outwardly from said handle such that each of said lobes is spaced from said top wall, each of said lobes being positioned proximate an associated one of said first end and said second end, said hose being wrapped around said handle such that said hose is positioned between said top wall and each of said lobes.
